(19) United States
(12) Patent Application Publication
(10) Pub. No.: US 2009/0004317 A1
(43) Pub. Date: Jan. 1, 2009

(54) HIGH THERMAL CONDUCTIVITY MOLDING COMPOUND FOR FLIP-CHIP PACKAGES

(76) Inventors: Xuejiao Hu, Phoenix, AZ (US); Leonel R. Arana, Phoenix, AZ (US); Robert M. Nickerson, Chandler, AZ (US); Rahul N. Manepalli, Chandler, AZ (US); Dingying Xu, Maricopa, AZ (US)

Correspondence Address: INTEL CORPORATION;c/o INTELLEVATE, LLC, P.O. BOX 52050, MINNEAPOLIS, MN, 55402, US

(21) Appl. No.: 11/772,200

(22) Filed: Jun. 30, 2007

(51) Int. Cl. B28B 5/00; C09K 5/00

(52) U.S. Cl. 425/352; 252/71

(57) ABSTRACT

A molding compound for use in an integrated circuit package comprises an epoxy and a thermally conductive filler material. The thermally conductive filler material comprises between 70% and 95% of the molding compound and has a thermal conductivity between 10 W/m-K and 3000 W/m-K.

### BACKGROUND

In the manufacture of integrated circuits, flip-chip molded matrix arrays packages (FCMMAP) are regarded as an attractive packaging solution for low power products due to their relatively small vertical height and low cost. A conventional FCMMAP 100 is illustrated in FIG. 1. A mold compound 102 surrounds the perimeter of an integrated circuit (IC) die 104. The mold compound 102 may also fill in the void beneath the IC die 104, as shown, or a separate material may be used beneath the die. The FCMMAP 100 further includes a substrate 106 coupling the IC die 104 to a ball grid array 108.

The mold compound 102 used in the FCMMAP 100, typically a mixture of an epoxy and a silica filler, has a low thermal conductivity that is generally in the range of 0.6 W/m-K to 0.8 W/m-K. This makes the mold compound 102 a barrier to heat dissipation. Therefore, to remove thermal energy from the IC die 104, a top surface of the IC die 104 must remain free of the mold compound 102. In some packages, a thermal management device is attached. As shown in FIG. 1, a thermally conductive adhesive layer 110, such as a thermal interface material (TIM), may be applied to the exposed top surface of the IC die 104. A thermal management device 112, such as a heat sink as shown in FIG. 1, is mounted on the adhesive layer 110 to dissipate thermal energy from the die 104.

The molding process requires the top surface of the mold compound 102 to be flush with the exposed top surface of the IC die 104. The application of the mold compound 102 must therefore be controlled to prevent overmolding onto the top surface of the IC die 104, otherwise a thermal management device 112 cannot be attached. This molding process becomes more challenging as the thickness of the IC die 104 decreases. Further, it can also cause warping and cracking issues for the thin IC die 104. Accordingly, the FCMMAP process needs to be improved.

### BRIEF DESCRIPTION OF THE DRAWINGS

FIG. 1 illustrates a conventional FCMMAP.

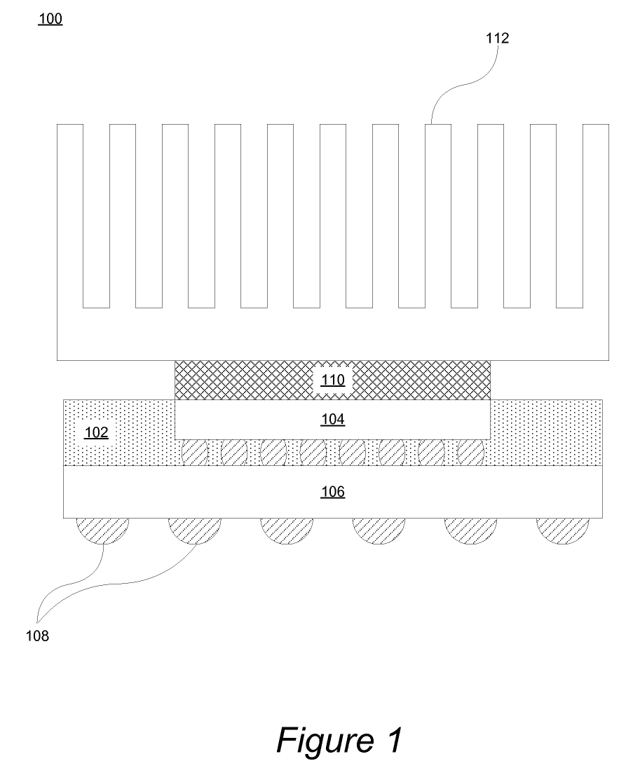

FIG. 2 illustrates an FCMMAP constructed in accordance with an implementation of the invention.

FIG. 3 illustrates an FCMMAP constructed in accordance with another implementation of the invention.

### DETAILED DESCRIPTION

Described herein are systems and methods of forming an integrated circuit package using a molding compound with good thermal conductivity. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

Implementations of the invention provide an improved integrated circuit package that is easier to produce and has improved thermal management. In accordance with implementations of the invention, a novel molding compound is used in the integrated circuit packaging process that has a greatly improved thermal conductivity. The higher thermal conductivity enables the molding compound to function as an integrated heat spreader to dissipate heat from the IC die. This novel molding compound of the invention may be used in any known integrated circuit packaging type, including but not limited to FCMMAP, wire bonded packages, and other packages that couple an integrated circuit die to second level interconnects such as a ball grid array, a land grid array, and a pin grid array. The following description of the invention describes the novel molding compound with reference to a FCMMAP. Please note, however, that the novel molding compound may be used with any integrated circuit packaging technology.

In accordance with implementations of the invention, the thermally conductive (TC) molding compound of the invention is a molding compound that may be used in integrated circuit packages and has a thermal conductivity that is high enough to provide sufficient passive cooling for the integrated circuit package. For instance, in some implementations of the invention, the TC molding compound has a thermal conductivity that falls between around 3 W/m-K and around 10 W/m-K. In further implementations, the thermal conductivity of the molding compound of the invention may be higher than 10 W/m-K, depending on the specific materials used in the compound, as described below.

The TC molding compound of the invention may consist of an epoxy resin and a thermally conductive filler material and other additives. Unlike conventional molding compounds, the use of a thermally conductive filler material substantially increases the overall thermal conductivity of the molding compound. In one implementation of the invention, the thermally conductive filler material may be alumina. Alumina has a thermal conductivity that is approximately 30 W/m-K. In implementations of the invention, the weight percentage of alumina in the molding compound may range from 30% to 99%, more preferably from 70% to 95%. Replacing silica with alumina as the filler material increases the overall thermal conductivity of the molding compound to a value that falls within the range provided above (i.e., 3 W/m-K to 10 W/m-K). This is a substantial improvement over the 0.6 W/m-K to 0.8 W/m-K thermal conductivity of conventional molding compounds.

In further implementations of the invention, alternate filler materials with high thermal conductivity may be used in the molding compound instead of alumina. For example, in some implementations, aluminum nitride having a thermal conductivity of around 180 W/m-K may be used. In other implementations, beryllium oxide having a thermal conductivity of around 260 W/m-K may be used. Metallic solids such as silver and non-metallic solids such as diamond, silicon, and silicon carbide may also be used. In some implementations, a combination of two or more of the above described filler materials may be used, such as a combination of two or more of alumina, aluminum nitride, and beryllium oxide. It should be noted that alternate filler materials having high thermal conductivities that are not specifically listed here may be used in accordance with implementations of the invention. For instance, in some implementations, alternate filler materials that may be combined with an epoxy for use in an integrated circuit package that have a thermal conductivity ranging from 10 W/m-K to 3000 W/m-K or more may be used. The key is using a filler material having a relatively high thermal conductivity that is compatible with the epoxy material used in the molding compound.

Thermally conductive molding compounds using filler materials such as alumina, aluminum nitride, or beryllium oxide have been shown to behave similarly to conventional molding compounds in molding processes. The thermally conductive molding compound of the invention, however, may be used with less stringent process constraints than required for conventional molding compounds.

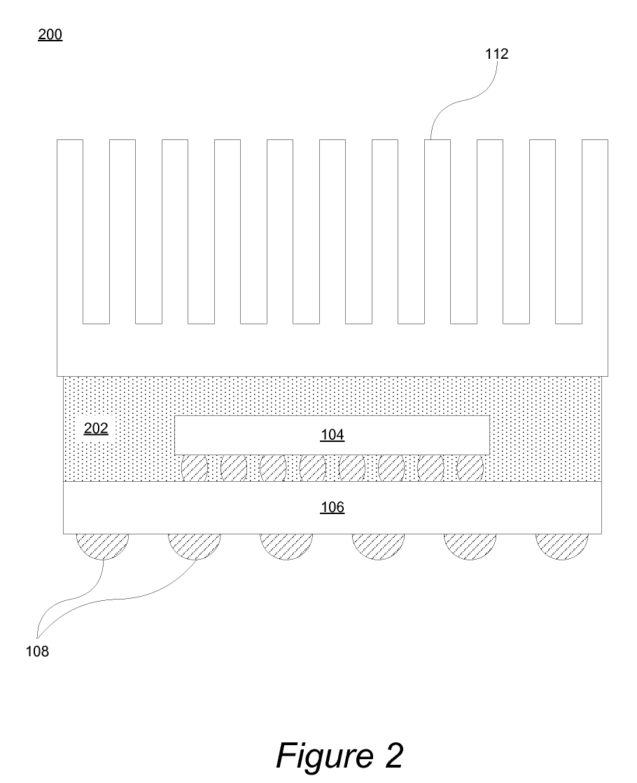

For instance, FIG. 2 illustrates a FCMMAP 200 that uses a TC molding compound 202 formed in accordance with an implementation of the invention. As shown in FIG. 2, the TC molding compound 202 completely encapsulates the IC die 104. Unlike conventional molding compounds, the TC molding compound 202 of the invention may be over-molded onto the top surface of the IC die 104 since it is a good conductor of thermal energy. This greatly simplifies the molding process since the top surface of the TC molding compound 202 no longer needs to be flush with the top surface of the IC die 104 and no longer needs to be kept off the top surface of the IC die 104. Rather, the TC molding compound 202 is intentionally over-molded to cover the top surface of the IC die 104.

Thermal energy from the IC die 104 is dissipated through the TC molding compound 202 to the thermal management device 112, such as the heat sink shown in FIG. 2. In some implementations, the TC molding compound 202 may replace the thermally conductive adhesive layer 110 and the thermal management device 112 can be attached directly to the surface of the TC molding compound 202. This is an added benefit since any resistance caused by the thermally conductive adhesive layer 110 is now eliminated. In other implementations, the thermally conductive adhesive layer 110 may be used between the TC molding compound 202 and the thermal management device 112.

As the TC molding compound 202 completely encapsulates the IC die 104, it is capable of providing a high degree of heat dissipation, functioning as an integrated heat spreader. In addition to conducting thermal energy to the thermal management device 112, the TC molding compound 202 can dissipate thermal energy to a substrate or motherboard upon which the FCMMAP 200 is mounted.

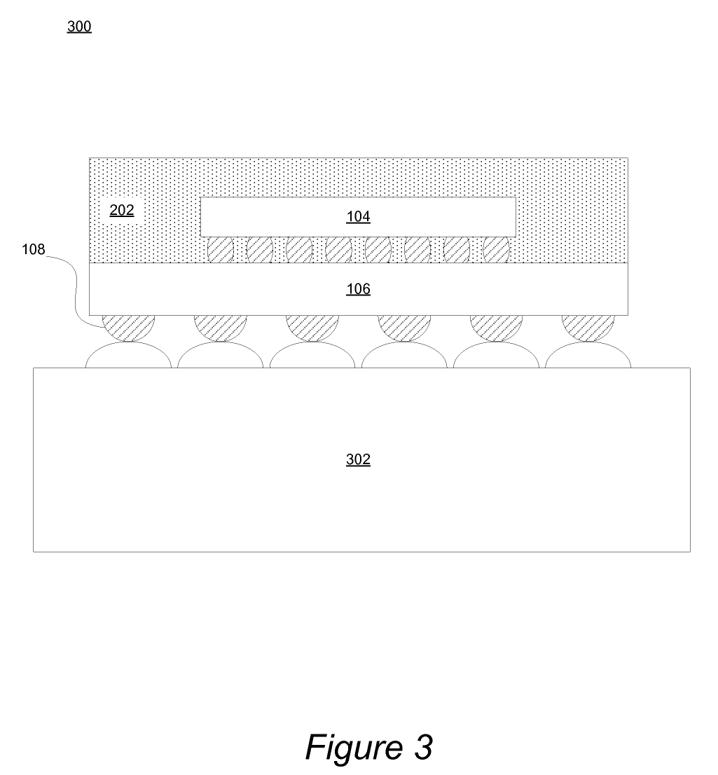

FIG. 3 illustrates another FCMMAP 300 constructed in accordance with another implementation of the invention. As shown in FIG. 3, the thermal management device 112 is not used and the TC molding compound 202 dissipates heat from the IC die 104 into the underlying substrate 106 for passive cooling. From the substrate 106, the thermal energy may be directed into a motherboard 302 that the FCMMAP 300 is mounted upon.

Implementations of the invention provide advantages over conventional FCMMAP processes. Allowing for complete over-molding of the IC die helps reduce process complexity and reduces the potential for warpage and cracking of the IC die, which decreases process costs, increases yield, and increase package reliability. The TC molding compound of the invention enables a thermal management device, such as a heat sink, to be directly attached to the TC molding compound without the need for a thermally conductive adhesive layer. Finally, the thermal conductivity of the TC molding compound of the invention improves heat spreading and increases heat dissipation through the motherboard for improved passive cooling.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. An apparatus comprising:
a molding compound for use in an integrated circuit package, the molding compound comprising:
an epoxy; and
a thermally conductive filler material.

2. The apparatus of claim 1, wherein the thermally conductive filler material is chosen from the group consisting of alumina, aluminum nitride, and beryllium oxide.

3. The apparatus of claim 1, wherein the thermally conductive filler material comprises between 70% and 95% of the molding compound.

4. The apparatus of claim 1, wherein the thermally conductive filler material comprises a filler material that may be combined with an epoxy for use in an integrated circuit package that has a thermal conductivity between 10 W/m-K and 3000 W/m-K.

5. An apparatus comprising:
a substrate having a second level interconnect;
an integrated circuit die mounted on the substrate;
a thermally conductive molding compound encapsulating the integrated circuit die; and
a thermal management device mounted onto the thermally conductive molding compound.

6. The apparatus of claim 5, wherein the thermally conductive molding compound comprises an epoxy and a thermally conductive filler material.

7. The apparatus of claim 6, wherein the thermally conductive filler material is chosen from the group consisting of alumina, aluminum nitride, and beryllium oxide.

8. The apparatus of claim 6, wherein the thermally conductive filler material comprises a filler material that may be combined with an epoxy for use in an integrated circuit package that has a thermal conductivity between 10 W/m-K and 3000 W/m-K.

9. The apparatus of claim 5, wherein the thermally conductive molding compound comprises a molding compound for use in an integrated circuit package having a thermal conductivity that falls between around 3 W/m-K and around 10 W/m-K.

10. The apparatus of claim 5, wherein the thermal management device comprises a heat sink.

11. The apparatus of claim 5, further comprising a thermally conductive adhesive layer formed between the thermally conductive molding compound and the thermal management device.

12. The apparatus of claim 5, wherein the second level interconnect comprises a ball grid array, a land grid array, or a pin grid array.

13. An apparatus comprising:
a substrate having a second level interconnect;
an integrated circuit die mounted on the substrate; and
a thermally conductive molding compound encapsulating the integrated circuit die.

14. The apparatus of claim 13, wherein the thermally conductive molding compound comprises an epoxy and a thermally conductive filler material chosen from the group consisting of alumina, aluminum nitride, and beryllium oxide.

15. The apparatus of claim 13, wherein the thermally conductive molding compound comprises a molding compound for use in an integrated circuit package having a thermal conductivity that falls between around 3 W/m-K and around 10 W/m-K.

16. The apparatus of claim 13, wherein the thermally conductive molding compound dissipates thermal energy from the integrated circuit die to a motherboard by way of the substrate and the second level interconnect.

17. The apparatus of claim 13, wherein the second level interconnect comprises a ball grid array, a land grid array, or a pin grid array.
